(19) United States
(12) Patent Application Publication
(10) Pub. No.: US 2024/0254299 A1
(43) Pub. Date: Aug. 1, 2024

(54) RESIN COMPOSITION AND PRODUCTION METHOD THEREOF, AND CLEANING METHOD OF RESIN MOLDING PROCESSING MACHINE

(71) Applicant: ASAHI KASEI KABUSHIKI KAISHA, Tokyo (JP)

(72) Inventors: Shunichiro I, Tokyo (JP); Daisuke MASAKI, Tokyo (JP)

(73) Assignee: ASAHI KASEI KABUSHIKI KAISHA, Tokyo (JP)

(21) Appl. No.: 18/423,711

(22) Filed: Jan. 26, 2024

(30) Foreign Application Priority Data
Jan. 27, 2023 (JP) 2023-011343

(51) Int. Cl. C08J 9/08; C08L 23/06; C10M 107/16; C11D 3/10; C11D 3/37; C10N 40/36

(52) U.S. Cl. CPC C08J 9/08; C08L 23/06; C10M 107/16; C11D 3/10; C11D 3/3749; C08J 2203/02; C08J 2323/06; C10M 2205/083; C10M 2205/143; C10N 2040/36; C11D 2111/20

(57) ABSTRACT

The present disclosure is directed to providing a resin composition that is excellent in shape retentionability and production stability, reduces die drool, and improves maintenance and management of production machines, and a cleaning method of a resin molding processing machine using the resin composition. The resin composition of the present disclosure contains at least (A) a polyethylene-based resin having a melting point of 121 to 140° C. and (B) an inorganic foaming agent. The mass ratio of the (A) component is 50 to 84 parts by mass and the mass ratio of the (B) component is 50 to 16 parts by mass when the total mass of the (A) component and the (B) component is taken as 100 parts by mass. The weight loss ratio measured using a TGA apparatus when heated from 25° C. to 200° C. under an inert gas atmosphere is 3.0 to 15 mass %.

### TECHNICAL FIELD

The present disclosure relates to a resin composition and a production method thereof, and a cleaning method of a resin molding processing machine using the resin composition.

### BACKGROUND

Resin molding processing machines (e.g., an extrusion molding machine and an injection molding machine) are generally used for processing such as coloring, mixing, and molding of resins. In molding processing machines in such types, additives such as a dye pigment originally contained in a resin or a molding material and degraded products (thermally decomposed products, burned products, carbides, etc.) generated from a resin or the like may remain in a molding processing machine after a certain operation ends. The residue would be mixed into a molded article in subsequent molding of the resin, which may cause appearance defects of products. In particular, because the mixing of burned products, carbides, and the like is readily recognized visually even in a tiny amount in a transparent resin, a molded article would have an appearance defect, resulting in a problem of an increase in the rate of defects of molded articles. Therefore, it is desired to completely remove residues out of a processing molding machine.

Conventionally, various methods have been employed for removing residues from a molding processing machine. Examples include (1) a method of disassembling and cleaning a molding processing machine manually, (2) a method of filling a molding processing machine with a molding material used for the next molding without stopping the molding processing machine, thereby gradually replacing (discharging) residues, and (3) a method of using a purging compound.

The method (1) has a problem in that the method is inefficient because molding processing machines are required to be stopped, and removal is physically carried out manually so that molding processing machines tend to be damaged. The method (2) has a problem in that a large amount of a molding material is required for the removal of residues, that it takes time to complete the operation, and that a large amount of waste is generated.

Therefore, in recent years, the above-described method (3) by using a purging compound has been frequently adopted.

In the above-described method (3), after purging with the purging compound and before performing the subsequent molding processing, the residual purging compound is usually replaced with the subsequent molding material. Therefore, the purging compound is required to have a high cleaning power against a molding material used in the previous molding process, and to have replaceability by a molding material to be used in the subsequent molding process. If a purging compound having a weak cleaning power is used, the previous molding material would remain in a molding processing machine and would be mixed into a subsequent molding material as a foreign matter. In addition, there tends to be a problem in that any remaining molding material after the molding processing machine is suspended degrades, and the degraded material is mixed in after the molding processing machine is started again.

Therefore, a method for enhancing the cleaning power of the purging compound to thereby prevent this problem has been proposed. For example, a technique has been disclosed that utilizes the effect of increasing the internal pressure of a molding processing machine by a gas generated by the decomposition of a foaming agent due to heating. Examples of such foaming agents include organic foaming agents and inorganic foaming agents, and inorganic foaming agents may be preferred from the viewpoint of their low odor.

As examples of a purging compound containing an inorganic foaming agent, PTL 1 discloses a purging compound in which sodium bicarbonate and a resin are dry-blended, and PTL 2 discloses a purging compound in which sodium bicarbonate is uniformly kneaded into a resin. PTL 3 discloses a purging compound in which an inorganic foaming agent master batch, which is a mixture of an inorganic foaming agent and a binder with a melting point of 120° C. or lower, is mixed with a thermoplastic resin.

### CITATION LIST

PTL 1: JP H09-208754 A
PTL 2: JP H10-81898 A
PTL 3: JP 2011-246609 A

### SUMMARY

In order to obtain a sufficient effect of increasing the internal pressure of a molding processing machine by a gas generated from a foaming agent (hereinafter also referred to as the “foaming effect”) to increase the cleaning power, it is necessary to add an appropriate amount of the foaming agent to the resin.

However, the present inventors have found that dry-blending sodium bicarbonate and a resin as disclosed in PTL 1 have a problem of difficulty in uniformly supplying sodium bicarbonate. Specifically, if a sufficient amount of sodium bicarbonate is mixed so as to achieve a foaming effect, separation between sodium bicarbonate and the resin occurs.

In addition, kneading sodium bicarbonate into a resin as disclosed in PTL 2 has a problem of production stability. Specifically, since the thermal decomposition temperature of the sodium bicarbonate is lower than the processing temperature of the resin, sodium bicarbonate thermally decomposes during processing.

Furthermore, pellets formed by processing a mixture of an inorganic foaming agent and a binder using a pressure granulator as disclosed in PTL 3 are less likely to retain their shape. The pellets may not retain the shape thereof during storage or transportation, leading to the generation of lumps or fine powder. These lumps or fine powder cause a problem of adhesion of the purging compound to the pneumatic system or a hopper of an extruder or a molding processing machine used. Additionally, due to the difference in specific gravity between pellets containing the inorganic foaming agent and the thermoplastic resin pellets, the separation between them (hereinafter also referred to as “classification”) may occur in the hopper, which may lead to variations in performance.

Therefore, an object of the present disclosure is to provide a resin composition that is excellent in shape retentionability and production stability, reduces die drool, and improves the maintenance and management of production machines and a production method thereof, and a cleaning method of a resin molding processing machine using the resin composition.

As a result of diligent investigation to solve the above-mentioned problem, the present inventors have discovered that a resin composition that contains a certain polyethylene-based resin having a certain melting point and an inorganic foaming agent in certain proportions, of which the weight loss ratio is controlled to a specific range, can solve the aforementioned problem, thereby completing the present disclosure.

Specifically, the present disclosure is as follows.
[1]
   A resin composition comprising at least (A) a polyethylene-based resin having a melting point of 121 to 140° C. and (B) an inorganic foaming agent,
   wherein a mass ratio of the (A) component is 50 to 84 parts by mass and a mass ratio of the (B) component is 50 to 16 parts by mass when a total mass of the (A) component and the (B) component is taken as 100 parts by mass, and
   a weight loss ratio measured using a thermogravimetric analysis (TGA) apparatus when heated from 25° C. to 200° C. under an inert gas atmosphere is 3.0 to 15 mass %.
[2]
   The resin composition according to [1], wherein, when the resin composition is pelletized, the pellets have a shape retention ratio of 99 mass % or more.
[3]
   The resin composition according to [1] or [2], further comprising (C) a lubricant.
[4]
   The resin composition according to any one of [1] to [3], wherein the (B) component is at least one selected from the group consisting of sodium bicarbonate, ammonium bicarbonate, ammonium carbonate, and ammonium nitrite.
[5]
   The resin composition according to any one of [1] to [4], wherein the (B) component is sodium bicarbonate, and an amount of residue when the resin composition is incinerated for 10 minutes under a condition of 600° C. in an air atmosphere is 9.0 mass % or more.
[6]
   The resin composition according to any one of [1] to [5], wherein the (B) component is sodium bicarbonate, and a ratio of the weight loss ratio to the amount of residue (the weight loss ratio/the amount of residue) when the resin composition is incinerated for 10 minutes under a condition of 600° C. in an air atmosphere is 0.30 to 0.56.
[7]
   The resin composition according to any one of [1] to [6], wherein a part or all of the (A) component is at least one selected from the group consisting of a material recycled polyethylene-based resin, a chemically recycled polyethylene-based resin, and a biomass-derived polyethylene-based resin.
[8]
   A production method of the resin composition according to any one of [1] to [7], comprising a melting-kneading step of melting-kneading the (A) component and the (B) component, the melting-kneading step comprising the following step (1-1) and step (1-2):
   the step (1-1) of melting-kneading a part or all of the (A) component and a part of the (B) component; and
   the step (1-2) of adding, to a melt-kneaded product obtained in the step (1-1), a remainder of the (A) component, unless all of the (A) component is used in the step (1-1), and a remainder of the (B) component, and performing melt-kneading.
[9]
   A production method of the resin composition according to any one of [1] to [7], comprising a melting-kneading step of melting-kneading the (A) component and the (B) component, the melting-kneading step comprising the following step (2-1) and step (2-2):
   the step (2-1) of melting-kneading a part or all of the (A) component; and
   the step (2-2) of adding, to a melt-kneaded product obtained in the step (2-1), a remainder of the (A) component, unless all of the (A) component is used in the step (2-1), and all of the (B) component, and performing melt-kneading
[10]
   A thermoplastic resin pellet comprising 100 parts by mass of the resin composition according to any one of [1] to [7] and 250 to 2000 parts by mass of (D) a thermoplastic resin.
[11]
   A cleaning method of a resin molding processing machine, comprising using the resin composition according to any one of [1] to [7].
[12]
   A cleaning method of a resin molding processing machine, comprising cleaning a resin molding processing machine using a mixture obtained by dry-blending 100 parts by mass of the resin composition according to any one of [1] to [7] and 250 to 2000 parts by mass of the (D) thermoplastic resin.

According to the present disclosure, it is possible to provide a resin composition that is excellent in shape retentionability and production stability, reduces die drool, and improves the maintenance and management of production machines and a production method thereof, and a cleaning method of a resin molding processing machine using the resin composition.

### DETAILED DESCRIPTION

The following provides a detailed description of an embodiment of the present disclosure (hereinafter, referred to as the “present embodiment”). Note that the present disclosure is not limited to the following present embodiment and may be implemented with various alterations that are within the essential scope thereof.

### <Resin Composition>

A resin composition of the present embodiment contains at least (A) a polyethylene-based resin having a melting point of 121 to 140° C. and (B) an inorganic foaming agent, wherein the mass ratio of the (A) component is 50 to 84 parts by mass and the mass ratio of the (B) component is 50 to 16 parts by mass when the total mass of the (A) component and the (B) component is taken as 100 parts by mass, and the weight loss ratio measured using a thermogravimetric analysis (TGA) apparatus when heated from 25° C. to 200° C. under an inert gas atmosphere is 3.0 to 15 mass %.

Thermal degradation (foaming due to thermal decomposition) of the (B) inorganic foaming agent is reduced and the content of unfoamed (B) inorganic foaming agent is high in the resin composition of the present embodiment. Thus, when the resin composition is used as a purging compound, the foaming effect by (B) the inorganic foaming agent is efficiently obtained and an excellent cleaning performance is achieved. Furthermore, the resin composition of the present embodiment maintains a high shape retention ratio when pelletized. This reduces the likelihood of pellets crumbling to form or fine powder or lumps during storage or transportation. As a result, when the resin composition is used as a purging compound, the adhesion to the pneumatic system or a hopper of the molding processing machine to be cleaned is reduced. Additionally, the resin composition of the present embodiment reduces occurrences of agglomerations such as pellets fused to one another (melted adhesive granules) during pelletization. This contributes to excellent production stability (extrusion stability). Furthermore, the resin composition of the present embodiment reduces die drool during production. Additionally, the ease of maintenance and management is achieved through the reduction in stickiness to the production apparatuses (reduced deposits to the die plate) or reduction in the burden of disassembly and cleaning.

Hereinafter, each component or the like of the resin composition of the present embodiment will be described in detail.

### <(A) Polyethylene-Based Resin>

The (A) polyethylene-based resin used in the present embodiment has a melting point of 121 to 140° C., preferably 125 to 140° C., and more preferably 129 to 140° C. from the viewpoint of reducing the thermal decomposition of the (B) inorganic foaming agent during the stage of production of the resin composition, as well as maintenance and management such as reduction in stickiness to the production apparatuses (kneader) and reduction in the burden of disassembly and cleaning.

Assuming, for example, the use of sodium bicarbonate as the (B) inorganic foaming agent, the present inventors have set the upper limit of the melting point of the (A) polyethylene-based resin to 140° C. to enable the resin composition to be produced while reducing thermal decomposition of the (B) inorganic foaming agent. It is considered that a polyethylene-based resin having a melting point within this temperature range can reduce the thermal decomposition of the (B) inorganic foaming agent even when an inorganic foaming agent other than sodium bicarbonate is used as the (B) inorganic foaming agent, and has little impact on the foaming power (foaming effect) of the resin composition containing the (B) inorganic foaming agent.

Note that the melting point of the (A) polyethylene-based resin can be determined by differential scanning calorimetry (DSC) in accordance with JIS K7121 in the present embodiment. When the melting point is measured by DSC, 5 mg of the sample resin is precisely weighed beforehand, placed in an aluminum pan, and sealed by a lid. The aluminum pan having the sample resin contained therein is placed on the sample stand of a DSC measurement apparatus, and the temperature is raised from 20° C. to 200° C. at a rate of 20° C./minute as the first temperature increase, and is held for 2 minutes after reaching 200° C. Next, the temperature is lowered from 200° C. to 20° C. at a rate of 20° C./min, held for 2 minutes after reaching 20° C., and then raised from 20° C. to 200° C. at a rate of 20° C./min as the second temperature increase. The temperature of the top peak of the DSC curve obtained during the above second temperature increase is determined as the melting point of that sample resin.

The (A) polyethylene-based resin is not particularly limited as long as it has a melting point of 121 to 140° C. From the viewpoint of reducing stickiness on the production machine (deposits to the die plate), preferred polyethylene-based resins include, for example, high-density polyethylene and linear low-density polyethylene, with high-density polyethylene is more preferred.

In addition, the (A) polyethylene-based resin is not particularly limited as long as it has a melting point of 121 to 140° C. A part or all of the polyethylene-based resin may be material recycled polyethylene-based resin, chemically recycled polyethylene-based resin, or biomass-derived polyethylene-based resin such as bionaphtha, etc., and the shape and form thereof are not particularly limited.

Note that one (A) polyethylene-based resin may be used alone, or two or more (A) polyethylene-based resins may be used together.

The melt flow rate (MFR) of the (A) polyethylene-based resin (at 190° C. under a load of 2.16 kg in accordance with ISO R1133) is preferably 0.2 g/10 min or more from the viewpoint of inhibiting thermal decomposition of the (B) inorganic foaming agent and is 20 g/10 min or less from the viewpoint of suppressing stickiness to the production machine (kneader), and is more preferably from 0.2 to 10 g/10 min, and even more preferably from 0.5 to 8 g/10 min. When multiple polyethylene-based resins are used, it is preferable that those within the above MFR range are mixed or those outside the above MFR range are mixed so that the MFR is adjusted within the above range.

### <(B) Inorganic Foaming Agent>

Any inorganic compound that decomposes upon heating and foams, i.e., generates a gas, can be used as the (B) inorganic foaming agent used in the present embodiment without any particular limitations. Examples of preferred (b) inorganic foaming agents include inorganic physical foaming agents such as water; and inorganic chemical foaming agents such as bicarbonates (e.g., sodium bicarbonate and ammonium bicarbonate), carbonates (e.g., sodium carbonate and ammonium carbonate), nitrites (e.g., ammonium nitrite), hydrides (e.g., sodium borohydride), azide compounds (e.g., calcium azide), light metals (e.g., magnesium and aluminum), a combination of sodium bicarbonate and an acid, a combination of hydrogen peroxide and yeast, and a combination of aluminum powder and an acid.

Of these inorganic foaming agents, sodium bicarbonate, ammonium bicarbonate, ammonium carbonate, and ammonium nitrite are preferred because the gas produced by foaming is less toxic, and they are inexpensive and thus economical, are easy to handle, have a high foaming power (pressure), and do not corrode steel. Of these, sodium bicarbonate is particularly preferred.

One of the above inorganic foaming agents may be used alone, or two or more of these may be used in combination.

With the resin composition of the present embodiment, when the content of the (B) inorganic foaming agent in the resin composition is set to a specific range, the grade and production stability (extrusion stability) of the resin composition can be enhanced. Specifically, from the viewpoint of inhibition of foaming of the resin composition and inhibition of melted adhesive granules of the resin composition, the weight loss ratio of the resin composition by a thermogravimetric analysis (TGA) is 3.0 to 15 mass %, preferably 5.0 to 11 mass %, and more preferably 6.5 to 10 mass %.

For example, when the (B) inorganic foaming agent is sodium bicarbonate, it thermally decomposes to produce carbon dioxide gas in a high temperature environment as follows.

$$2 N a H C {O}_{3} - > N {a}_{2} C {O}_{3} + C {O}_{2} + {H}_{2} O$$

Therefore, the content of the (B) inorganic foaming agent that has not been thermally decomposed (or the mass ratio of the (B) inorganic foaming agent that has been thermally decomposed) in the resin composition can be calculated by measuring the weight loss due to the loss of components derived from the (B) inorganic foaming agent (CO₂ and H₂O in the case of sodium bicarbonate) using TGA. If the (B) inorganic foaming agent is contained within the resin composition without being thermally decomposed, it will efficiently generate gas at normal cleaning operation temperatures. The resin composition containing the (B) inorganic foaming agent without being thermally decomposed has excellent cleaning power for resin molding processing machines due to the foaming effect thereof. In addition, the use of the resin composition has the effect of preventing thermal degradation when the use of the molding processing machine is stopped.

Note that the weight loss ratio of the resin composition is measured by heating the resin composition from 25° C. to 200° C. under an inert gas atmosphere using a TGA apparatus.

When the (B) inorganic foaming agent is sodium bicarbonate, the amount of residue when the resin composition of the present embodiment is incinerated for 10 minutes under a condition of 600° C. in an air atmosphere is preferably 9.0 mass % or more, more preferably 12.0 mass % or more, and even more preferably 15.0 mass % or more, from the viewpoint of cleaning performance. The upper limit of the amount of residue is not particularly limited, but is 31 mass % or less, for example.

Furthermore, when the (B) inorganic foaming agent is sodium bicarbonate, the ratio of the weight loss ratio to the amount of residue (weight loss ratio/amount of residue) is preferably 0.30 to 0.56, more preferably 0.42 to 0.56, and even more preferably 0.44 to 0.56 from the viewpoint of cleaning performance, extrudability, and classification.

In order to control the weight loss ratio (the content of the (B) inorganic foaming agent) and/or the ratio of the weight loss ratio to the amount of residue of the resin composition within specific ranges, it is preferable to adjust, for example, the type of production machine (extruder) used to produce the resin composition, or the temperature, the screw rotation speed, or the screw configuration during melt-kneading.

The resin composition of the present embodiment has an excellent shape retention ratio when pelletized. Specifically, from the viewpoint of storage and transportation of pellets, it is preferable that pellets have a shape retention ratio of 99.0 mass % or more, and more preferably 99.5 mass % or more.

Note that the shape retention ratio of pellets is determined by pelletizing the resin composition into pellets with a long diameter of 3 to 4 mm and a short diameter of 2 to 3 mm and determining the mass ratio of the pellets of which shape is retained before and after applying a load of 20 kg. Specifically, it can be determined using the method described the Examples section below.

The resin composition of the present embodiment is made from the (A) component and the (B) component described above as the principal ingredients. From the viewpoint of extrusion stability during processing, when the total mass of the (A) component and the (B) component is taken as 100 parts by mass, the mass ratio of the (A) component is 50 to 84 parts by mass and the mass ratio of the (B) component is 50 to 16 parts by mass, it is preferable that the mass ratio of the (A) component is 60 to 84 parts by mass and the mass ratio of the (B) component is 40 to 16 parts by mass, and it is more preferable that the mass ratio of the (A) component is 70 to 84 parts by mass and the mass ratio of the (B) component is 30 to 16 parts by mass.

Note that the mass ratio of the (A) component and the mass ratio of the (B) component described above are the charged ratios of the amount of the (A) component and the amount of the (B) component (blended amounts) when production of the resin composition, and the respective charged ratios of the amount of the (A) component and the amount of the (B) component can be determined from the residue of the (B) component in an ash content measurement of the obtained resin composition. In addition, the melting point of the (A) component used in the resin composition can be confirmed by DSC as described above in a similar manner.

### <(C) Lubricant>

The resin composition of the present embodiment may further include (C) a lubricant.

Examples of the (C) lubricant used for the present embodiment are not limited, but include, for example, fatty acid alkali metal salts, fatty acid waxes, and fatty acid ester waxes, and montanic acid ester wax is particularly preferred. In addition, polyethylene waxes, polypropylene waxes, low molecular weight polyethylene (excluding the (A) polyethylene-based resin), low molecular weight polypropylene, or the like can also be used as the (C) lubricant. Low molecular weight polyethylene and low molecular weight polypropylene are those with a weight average molecular weight of less than 50,000.

These can be modified with other resins, acids, bases, or the like, depending on the application.

One (C) lubricant may be used alone or two or more of these may be used in combination.

The content of the (C) lubricant is preferably in the range of 1 to 30 parts by mass, more preferably in the range of 1 to 20 parts by mass, and particularly preferably in the range of 1 to 10 parts by mass, with respect to 100 parts by mass of the total of the (A) component and the (B) component.

### <Additive>

The resin composition of the present embodiment may contain additives depending on the application, etc. Examples of additives include, for example, mineral oil, an inorganic compound other than the (B) inorganic foaming agent, a surfactant, a fluorine compound, an antioxidant, and an ultra-high molecular weight resin. Among them, it preferably further contains at least one selected from the group consisting of mineral oil, an inorganic compound other than the (B) inorganic foaming agent, a surfactant, and a fluorine compound.

These additives will be described below.

### <Mineral Oil>

Mineral oil used in the present embodiment is oil obtained through the refining of petroleum, and is a saturated hydrocarbon-based oil including naphthene, isoparaffin, and the like, also called mineral oil, lubricating oil, liquid paraffin, and the like. Mineral oils having a wide viscosity range can be used, for example, liquid paraffin having a kinematic viscosity measured according to JIS K2283 of 50 to 500 mm²/s, or liquid paraffin having a viscosity measured by the Redwood method (Japanese Oil Chemicals Association Standard Oil Analytical Test Method 2.2.10.4-1996) of 30 to 2000 seconds may be used.

The content of mineral oil is preferably 1 to 10 parts by mass, more preferably 2 to 5 parts by mass with respect to 100 parts by mass of the total of the (A) component and the (B) component.

### <Inorganic Compound>

The resin composition of the present embodiment may contain an inorganic compound other than the (B) inorganic foaming agent The inclusion of an inorganic compound other than the (B) inorganic foaming agent not only improves the dispersibility of the (B) inorganic foaming agent, but also a finer foaming state is achieved during purging and provides the effect of physically scraping off the resin remaining inside the molding processing machine.

The inorganic compound other than the (B) inorganic foaming agent that can be used may be either a natural product or an artificial synthetic product. Specific examples of such an inorganic compound include talc, mica, wollastonite, zonotraite, kaolin clay, montmorillonite, bentonite, sepiolite, imogolite, sericite, lawsonite, smectite, calcium carbonate, magnesium carbonate, titanium oxide, aluminum hydroxide, magnesium hydroxide, zeolite, diatomaceous earth, glass powder, glass ball, and shirasu balloon.

One of these inorganic compounds may be used alone or two or more of these may be used.

The shape of these inorganic compounds is not particularly limited and may be in any shape (plate shape, needle shape, particulate shape, fiber shape, etc.). These inorganic compounds may be fired ones, or may have been subjected to surface hydrophobic treatment with, for example, a silane coupling agent or a titanate coupling agent.

The average particle diameter of these inorganic compounds is preferably 0.1 to 500 μm, more preferably 0.5 to 100 μm, even more preferably 1 to 50 μm, particularly preferably 2 to 30 μm, and most preferably 3 to 20 μm.

Note that the average particle diameter can be determined with a laser diffraction method (using SALD-2000 manufactured by Shimadzu Corporation, for example).

From the viewpoint of achieving a finer foaming state during purging and obtaining sufficient effect of physically scraping off the resin remaining inside the molding processing machine, the content of the inorganic compound is preferably 5 to 80 parts by mass and more preferably 20 to 75 parts by mass with respect to 100 parts by mass of the total of the (A) component and the (B) component.

### <Surfactant>

Examples of the surfactant used for the present embodiment include anionic surfactants, cationic surfactants, nonionic surfactants, and amphoteric surfactants. Of these, a surfactant that remains liquid at room temperature is preferable. Examples of the anionic surfactants include higher fatty acid alkali salts, alkyl sulfuric acid salts, alkyl sulfonic acid salts, alkyl aryl sulfonic acid salts, and sulfosuccinic acid ester salts. Specific examples of the cationic surfactants include higher amine halogen acid salts, alkylpyridinium halides, and quaternary ammonium salts. Specific examples of the nonionic surfactants include polyethylene glycol alkyl ether, polyethylene glycol fatty acid esters, sorbitan fatty acid esters, and fatty acid monoglycerides Specific examples of amphoteric surfactants include amino acids.

One of the above surfactants may be used alone, or two or more of these may be used in combination.

The content of the surfactant is preferably in the range of 1 to 30 parts by mass, more preferably in the range of 1 to 20 parts by mass, and particularly preferably in the range of 1 to 10 parts by mass, with respect to 100 parts by mass of the total of the (A) component and the (B) component.

### <Fluorinated Compound>

As the fluorinated compound used for the present embodiment, polytetrafluoroethylene, tetrafluoroethylene-ethylene copolymers, and tetrafluoroethylene-perfluoroalkyl vinyl ether copolymers can be used. Acrylic modified compounds of the above-described compounds are more preferred, and polytetrafluoroethylene modified with an acrylic resin and copolymers thereof are particularly preferred.

One of the above-described fluorinated compounds may be used alone, or two or more of these may be used in combination.

The content of the fluorinated compound is preferably 0.5 to 20 parts by mass, more preferably 1 to 15 parts by mass, particularly preferably 2 to 10 parts by mass, with respect to 100 parts by mass of the total of the (A) component and the (B) component.

### <Antioxidant>

Examples of the antioxidant include, but are not limited to, phosphorus-based antioxidants and phenolic antioxidants. Specific examples of phosphorus-based antioxidants include tris(2,4-di-t-butylphenyl)phosphite, bis(2,4-di-t-butylphenyl)pentaerythritol diphosphite, and 2,2′-methylenebis (4,6-di-t-butyl-1-phenyloxy)(2-ethylhexyloxy)phosphite. Specific examples of the phenolic antioxidants include pentaerythritol tetrakis[3-(3,5-di-t-butyl-4-hydroxyphenyl)propionate], octadecyl-3-(3,5-di-t-butyl-4-hydroxyphenyl)propionate, and 4,4′-butylidenebis(6-t-butyl-m-cresol).

One of the antioxidants may be used alone or two or more of these may be used in a combination.

The content of the antioxidant is preferably 0.01 to 5 parts by mass, more preferably 0.05 to 3 parts by mass, and even more preferably 0.1 to 2 parts by mass, with respect to 100 parts by mass of the total of the (A) component and the (B) component. The content of the antioxidant in the above range is preferable because the degradation of the resin can be suppressed and the decomposition products of the antioxidant per se have little inhibitory effect on other additives (lubricant or the like).

### <Ultra-High Molecular Weight Resin>

In the present disclosure, an ultra-high molecular weight resin is a polymer having a molecular weight of 1,000,000 or more, and examples thereof include an ethylene-based ultra-polymer, a styrene-acrylonitrile-based ultra-polymer, and a methyl methacrylate-based ultra-polymer. Of these, an ethylene-based ultra-polymer is preferable. The upper limit of the molecular weight is not particularly limited, but is generally preferably 10,000,000 or less for practical use.

Further, the ultra-high molecular weight resin may be either a homopolymer or a copolymer. In the case of a copolymer, the content of the main component (for example, ethylene, a styrene-acrylonitrile copolymer, a methyl methacrylate, and the like) is required to be 50 mass % or more.

Note that the above-mentioned (A) polyethylene-based resin shall not be included in the ultra-high molecular weight resin.

From the viewpoint of cleaning power and replaceability, the content of ultra-high molecular weight resin is preferably 0.1 to 10 parts by mass, more preferably 0.2 to 7 parts by mass, and even more preferably 0.35 parts by mass, with respect to the total of the component (A) and the component (B).

### [Production Method of Resin Composition]

The production method of the resin composition of the present composition is not limited and can be produced by kneading using known kneading machines. For example, heating and melting-kneading can be carried out by a single screw extruder, a single screw reciprocating extruder, a multiple screw extruder including a twin screw extruder, a roll, a kneader, a Brabender plastograph, and a Banbury mixer. Of these, melt-kneading using a single screw extruder, single screw reciprocating extruder, or twin screw extruder is preferred, and melt-kneading using a single screw reciprocating extruder is more preferred because it can further reduce thermal decomposition of the (B) inorganic foaming agent. Specifically, the MDK and COMPEO series manufactured by Buss AG, the ZSK series manufactured by Coperion GmbH, the TEM series manufactured by SHIBAURA MACHINE CO., LTD., and the TEX series manufactured by Japan Steel Works, Ltd. can be used. The L/D ratio (barrel effective length (L)/barrel inner diameter (D)) of the extruder is not particularly limited, but is, for example, preferably 10 to 60, more preferably 20 to 50.

The melt-kneading temperature (e.g., the temperature setting of the cylinder during melt-kneading in an extruder) and the screw rotation speed are not particularly limited. However, in order to keep the weight loss ratio (the content of the (B) inorganic foaming agent) of the resin composition within a specific range, for example, it is preferable to set the melt-kneading temperature to a temperature higher than the melting point of the (A) polyethylene-based resin, which is the main component, by 10 to 30° C., and it is also preferable to control the weight loss ratio of the resin composition by adjusting the screw rotation speed and screw configuration during melt-kneading in the extruder. For example, the melt-kneading temperature is preferably 130 to 170° C. and the screw rotation speed is preferably 100 to 400 rpm.

The production method of the resin composition of the present embodiment preferably includes a melt-kneading step of melt-kneading the (A) polyolefin-based resin and the (B) inorganic foaming agent, by the following melt-kneading method 1 or melt-kneading method 2 because it becomes easier to control the weight loss ratio of the resin composition within the range of 3.0 to 15 mass %. In particular, in the production method that includes a melt-kneading step of melt-kneading the (A) polyolefin resin and the (B) inorganic foaming agent in an extruder, it is preferred that the following melt-kneading method 1 or melt-kneading method 2 is satisfied.

### (Melt-Kneading Method 1)

the step (1-1) of melting-kneading a part or all of the (A) component and a part of the (B) component; and
the step (1-2) of adding, to a melt-kneaded product obtained in the step (1-1), the remainder of the (A) component, unless all of the (A) component is used in the step (1-1), and the remainder of the (B) component, and performing melt-kneading

### (Melt-Kneading Method 2)

the step (2-1) of melting-kneading a part or all of the (A) component; and
the step (2-2) of adding, to a melt-kneaded product obtained in the step (2-1), the remainder of the (A) component, unless all of the (A) component is used in the step (2-1), and all of the (B) component, and performing melt-kneading

In the above melt-kneading method 1, preferably 20 to 100 mass %, more preferably 30 to 90 mass % of the (A) component is used with respect to 100 mass % of the total mass thereof, in the step (1-1).

Further, in the above melt-kneading method 1, preferably 20 to 100 mass %, more preferably 30 to 90 mass % of the (B) component is used with respect to 100 mass % of the total mass thereof, in the step (1-1).

In the above melt-kneading method 2, preferably 20 to 100 mass %, more preferably 30 to 90 mass % of the (A) component is used with respect to 100 mass % of the total mass thereof, in the step (2-1).

The thermal history of the (B) component during melt-kneading can be further reduced by delaying the timing to add a part or all of the (B) component (in other words, a part or all of the (B) component is added later), which is effective in improving cleaning performance, in the melt-kneading step as in the above melt-kneading method 1 or 2.

Examples of the method of delaying the timing to add the (B) component include, for example, adding the (B) component from the material feed port on a downstream side of the melt-kneading machine or kneading extruder.

### <Thermoplastic Resin Pellets>

Thermoplastic resin pellets of the present embodiment include the resin composition of the present embodiment described above and (d) a thermoplastic resin.

The thermoplastic resin pellets of the present embodiment can be obtained, for example, by mixing the above resin composition of the present embodiment and the (D) thermoplastic resin using a known mixing apparatus (e.g., tumbler, ribbon blender, super mixer, etc.).

The mass ratio of the (D) thermoplastic resin in the thermoplastic resin pellets is preferably 250 to 2000 parts by mass, more preferably 300 to 2000 parts by mass, and even more preferably 350 to 2000 parts by mass, with respect to 100 parts by mass of the resin composition. When the mass ratio of the (D) thermoplastic resin is within the above-mentioned range, there tends to be a good balance between cleaning performance and replaceability by a molding material after cleaning.

### <(D) Thermoplastic Resin>

As the (D) thermoplastic resin used in the present embodiment, a wide range of thermoplastic resins used for general injection molding, extrusion molding, or the like can be used.

Specific examples of the (D) thermoplastic resin include styrene-based resins such as polystyrene, olefin-based resins such as ethylene-based resins (e.g., polyethylene) and propylene-based resins (e.g., polypropylene), methacrylic ester-based resins such as polymethyl methacrylate, polyvinyl chloride, polyamide-based resins, polycarbonate, and polybutene. Of these, styrene-based resins and polyolefin-based resins are preferred.

One of the (D) thermoplastic resins may be used alone, or two or more of these may be used together.

A styrene-based resin refers to polystyrene or a copolymer of styrene and one or more other monomers having the content of a monomer unit derived from styrene of 50 mass % or more. Examples of other monomers copolymerized with styrene include acrylonitrile and butadiene, for example.

Specific examples of the styrene-based resin include polystyrene, a styrene-acrylonitrile copolymer, and a styrene-butadiene-acrylonitrile copolymer. Of these, polystyrene and a styrene-acrylonitrile copolymer are preferred, especially a styrene-acrylonitrile copolymer having the content of a monomer unit derived from acrylonitrile of 5 mass % or more and less than 50 mass % is preferred because it has an excellent cleaning performance and foreign substances is less likely to remain in a resin molding processing machine.

Olefin-based resins may be ethylene-based resins, propylene-based resins, or copolymers of ethylene and propylene with α-olefins.

Note that the compound used as an additive to the resin composition can also be used as an additive to the (D) thermoplastic resin. The additive may be added to only one of the resin composition and the (D) thermoplastic resin, or may be added to both of them. Whether an additive is added or not and whether it is added to the resin composition or the (D) thermoplastic resin can be selected according to the purpose and function of the additive.

### [Cleaning Method of Resin Molding Processing Machine]

The resin composition and thermoplastic resin pellets of the present embodiment described above can be used as a purging compound.

A cleaning method of a resin molding processing machine of the present embodiment uses the resin composition or thermoplastic resin pellets of the present embodiment described above. The cleaning method of a resin molding processing machine may include the step of causing the resin composition or thermoplastic resin pellets described above to remain in the resin molding processing machine.

Specific examples of the resin molding processing machine that can be cleaned using the resin composition of the present embodiment are any resin molding processing machines that process thermoplastic resins, and include, but are not specifically limited to, injection molding machines, extrusion molding machines, and 3D printers.

The cleaning method of a resin molding processing machine according to the present embodiment can promote efficient discharge of a molded-processed material before cleaning. In addition, the cleaning method causes the resin composition or thermoplastic resin pellets to remain filled in the resin molding processing machine in cases where the resin molding processing machine is suspended after cleaning. This is advantageous in that, even if the molded-processed material before the cleaning remains in the resin molding processing machine due to insufficient cleaning, thermal degradation of the remaining material is prevented. This effect is due to the fact that the resin molding processing machine is suspended while the gas generated from the (B) inorganic foaming agent used in the present embodiment remains filled in the machine, thereby suppressing oxidative deterioration of the remaining material.

The cleaning method of a resin molding processing machine of the present embodiment may perform cleaning using a mixture obtained by dry-blending 250 to 2000 parts by mass of the (D) component with 100 parts by mass of the resin composition. This method greatly simplifies the process.

The mass ratio of the (D) thermoplastic resin to be dry-blended is preferably 300 to 2000 parts by mass, more preferably 350 to 2000 parts by mass with respect to 100 parts by mass of the resin composition. When the mass ratio of the (D) thermoplastic resin is within the above range, there tends to be a good balance between cleaning performance and replaceability by molding materials after cleaning.

### EXAMPLES

Hereinafter, the present embodiment will be specifically described with reference to examples and comparative examples. However, the present embodiment is not limited by the examples mentioned later without departing from the spirit of the present embodiment.

Raw materials used in resin compositions of the examples and comparative examples and various measurement methods will be described below.

### [Raw Materials]

### (A) Polyethylene-Based Resin

(A-1) High-density polyethylene resin (MFR: 5.5 g/10 min, melting point: 134° C.)
(A-2) Low-density polyethylene resin (MFR: 0.1 g/10 min, melting point: 132° C.)
(A-3) Linear low-density polyethylene resin (MFR: 0.8 g/10 min, melting point: 126° C.)

### Other Polyethylene-Based Resin

(A-4) Low-density polyethylene resin (MFR: 2.0 g/10 min, melting point: 110° C.)

### (B) Inorganic Foaming Agent

(B-1) Sodium bicarbonate (manufactured by AGC, Inc.)

### (C) Lubricant

(C-1) Polyethylene wax (SANWAX 131-P manufactured by SANYO Chemical Industries, Ltd.)

### [Measurement of Melt Mass Flow Rate (MFR) of Polyethylene-Based Resin]

The MFRs of polyethylene-based resins were measured at 190° C. under a load of 2.16 kg according to ISO R1133.

### [Measurement of Melting Point of Polyethylene-Based Resins]

The melting points (° C.) of polyethylene-based resins were measured by DSC in accordance with JIS K7121. As a sample, 5 mg of a polyethylene-based resin was precisely weighed. The sample was placed in an aluminum pan and sealed with a lid. The aluminum pan having the sample contained therein was placed on the sample stand of a differential scanning calorimeter (DSC 3500 manufactured by NETZSCH Japan K. K.), and the temperature was raised from 20° C. to 200° C. at a rate of 20° C./minute as the first temperature increase under a nitrogen atmosphere, and held for 2 minutes after reaching 200° C. Next, the temperature was lowered from 200° C. to 20° C. at a rate of 20° C./min, held for 2 minutes after reaching 20° C., and then increased from 20° C. to 200° C. at a rate of 20° C./min as the second temperature increased. The temperature of the top peak of the DSC curve obtained during the second temperature increase described above was determined as the melting point of the sample.

### (1) Weight Loss Ratio of Resin Composition

A measurement was carried out on each resin composition obtained in examples and comparative examples under a nitrogen atmosphere under the following measurement conditions using TG-DTA2500 manufactured by ETZSCH Japan K. K. The weight loss ratio (mass %) from the start to the end of the measurement was calculated.

### (Measurement Conditions)

Amount of sample: Approximately 10 mg

Measurement condition: temperature was increased from 25° C. to 200° C. at 20° C./min

### (2) Amount of Residue of Resin Composition

The amount of residue (mass %) when each resin composition obtained in the examples and comparative examples was incinerated for 10 minutes under a condition of 600° C. in an air atmosphere was calculated using the following formula.

$$Amount of residue ( mass \% ) = ( mass after incineration / mass before incineration ) \times 100$$

### (3) Ratio of Weight Loss Ratio to Amount of Residue

For each resin composition obtained in the examples and comparative examples, the ratio of the weight loss ratio to the amount of residue was calculated using the following formula.

$$Ratio of weight loss ratio to amount of residue = weight loss ratio ( mass \% ) / amount of residue ( mass \% )$$

### (4) Shape Retention Ratio of Pellets

In a bag, 100 g (W1) of pellets (having a long diameter of 3 to 4 mm and a short diameter of 2 to 3 mm) of each resin composition obtained in the examples and comparative examples were packaged, and a load of 20 kg was uniformly applied for 1 hour. Pellets that retained their shape without crumbling to form powder or lumps after 1 hour were taken out, and the shape retention ratio (mass %) was calculated from their mass (W2) using the following formula.

$$Shape retention ratio of pellets ( mass \% ) = ( W 2 / W 1 ) \times 100$$

### (5) Observation of Classification

Pellets of each resin composition obtained in the examples and comparative examples were fed into a gravimetric feeder equipped with a hopper for feeding pellets and a screw for feeding. The state of classification of pellets discharged from the gravimetric feeder was visually observed and judged according to the following criteria.

### (Determination Criteria)

++: Classification was hardly observed
+: Progress of classification was observed

### (6) Production Stability (Extrusion Stability)

After weighing 1 kg of pellets of each resin composition obtained in the examples and comparative examples, pellets fused to one another (melted adhesive granules) were taken out and their mass was measured.

The mass ratio thereof was calculated and judged according to the following criteria. A smaller ratio of melted adhesive granules indicates better production stability (extrusion stability). If pellets were not continuously discharged from the cutter during extrusion, or if the yield was poor, the evaluation was determined as “extrusion impossible.”

### (Determination Criteria)

+++: The ratio of melted adhesive granules was less than 10 mass %.
++: The ratio of melted adhesive granules was 10 mass % or more and less than 20 mass %
+: The ratio of melted adhesive granules was 20 mass % or more or extrusion was impossible

### (7) Die Drool

During the production of each resin composition in the examples and comparative examples, extrusion was continued for 15 minutes each, and the quantity of die drool generated at the die inlet was observed. The following determination criteria were used.

### (Determination Criteria)

+++: No die drool was generated during the entire period of 15 minutes
++: A small quantity of die drool was observed to be generated during the period of 15 minutes.
+: A large quantity of die drool was observed to be generated during the period of 15 minutes.

### (8) Scrapability by Scraper

During the production of each resin composition in the examples and comparative examples, the resin discharged from the die plate orifice outlet of the extruder die section was scraped off with a scraper and judged according to the following criteria.

### (Determination Criteria)

+++: A small quantity of resin was observed to adhere to the die plate
++: A somewhat fair quantity of resin was observed to adhere to the die plate
+: A large quantity of resin was observed to adhere to the die plate

### Example 1

A resin composition was produced by blending ingredients in the ratios listed in Table 1 and using a single screw reciprocating extruder (MDK46 manufactured by Buss AG). The extruder was provided with a first material feed port located on the upstream side in the direction of the material flow and a second material feed port located downstream to the first material feed port, and ingredients were fed from the feed ports listed in Table 1. Kneading conditions were the barrel setting temperature of 130 to 150° C. and the screw rotation speed of 120 rpm. The thus obtained melt-kneaded product was cut with a cutter to obtain pellets of the resin composition (having a long diameter of 3 to 4 mm and a short diameter of 2 to 3 mm). The melting point of the obtained pellets was measured in the same manner as in [Measurement of melting point of polyethylene-based resins] described above, and was determined to be 135° C.

### Example 2

Pellets of a resin composition (having a long diameter of 3 to 4 mm and a short diameter of 2 to 3 mm) were obtained by melt-kneading in the same manner as in Example 1, except that the rotation speed of the single screw reciprocating extruder was set to 180 rpm.

### Example 3 to 7

A resin composition was produced by blending ingredients in the ratios listed in Table 1 and using a twin screw extruder (TEM-26SX manufactured by SHIBAURA MACHINE CO., LTD.). The extruder was provided with a first material feed port located on the upstream side in the direction of the material flow and a second material feed port located downstream to the first material feed port, and ingredients were fed from the feed ports listed in Table 1. The kneading conditions were the barrel setting temperature of 130 to 160° C. and the screw rotation speed of 120 rpm. The thus obtained melt-kneaded product was cut with a cutter to obtain pellets of the resin composition (having a long diameter of 3 to 4 mm and a short diameter of 2 to 3 mm).

### Comparative Examples 1 and 2

Pellets of the resin composition (having a long diameter of 3 to 4 mm and a short diameter of 2 to 3 mm) were obtained by blending ingredients in the ratios listed in Table 1, and melt-kneading in the same manner as in Example 3, except that the barrel setting temperature of the twin screw extruder was changed to 220° C. and the feeding position of the (B) component was changed to the first material feed port.

### Comparative Example 3

Pellets of the resin composition (having a long diameter of 3 to 4 mm and a short diameter of 2 to 3 mm) were obtained by blending ingredients in the ratios listed in Table 1, and melt-kneading in the same manner as in Example 3, except that the barrel setting temperature of the twin screw extruder was changed to 110 to 140° C.

### Comparative Example 4

A blending of 25 parts by mass of the (B-1) component, 10 parts by mass of polyolefin wax (Licoce ne PP1302 manufactured by Clariant Japan), 5 parts by mass of a lubricant (Licowax E manufactured by Clariant Japan), and 60 parts by mass of calcium carbonate (KK3000 manufactured by Shimizu Industrial Co. Ltd.) was carried out at this ratio, which was all fed into a continuous pressure granulator from the same feed port, extruded, and molded. Pellets (having a long diameter of 3 to 4 mm and a short diameter of 2 to 3 mm) were obtained by cutting strands discharged from the granulator with a rotating knife cutter. The pellets obtained in the granulator were mixed with the (A-1) component at a ratio of 5 parts by mass of the pellets and 95 parts by mass of the (A-1) component. The shape retention ratio of the pellets was 97.5 mass %.

### Comparative Example 5

The (B-1) component and a lubricant (Licowax E manufactured by Clariant Japan) were blended in a ratio of 95 parts by mass of the (B-1) component and 5 parts by mass of the lubricant, which was all fed into a continuous pressure granulator from the same feed port, extruded, and molded. Pellets (having a long diameter of 3 to 4 mm and a short diameter of 2 to 3 mm) were obtained by cutting strands discharged from the granulator with a rotating knife cutter. The pellets obtained in the granulator were mixed with the (A-1) component at a ratio of 25 parts by mass of the pellets and 75 parts by mass of the (A-1) component. The ratio of weight loss ratio to the amount of residue measured after adjusting to this mixing ratio was 0.58, and the determination result of the observation of classification was +.

The measurement and evaluation results of the examples and comparative examples were summarized in Table 1.

TABLE 1

| | | | | | | | | | | Compar- | Compar- | Compar- |
|---|---|---|---|---|---|---|---|---|---|---|---|---|
| | | | Exam- | Exam- | Exam- | Exam- | Exam- | Exam- | Exam- | ative | ative | ative |
| | | | ple 1 | ple 2 | ple 3 | ple 4 | ple 5 | ple 6 | ple 7 | Example 1 | Example 2 | Example 3 |
| First | (A-1) High density | parts | 75 | 75 | 75 | 60 | 75 | | 75 | | | |
| material | polyethylene resin | by mass | | | | | | | | | | |
| feed supply | (A-2) High density | parts | | | | | | | | 85 | 75 | |
| port | polyethylene resin | by mass | | | | | | | | | | |
| | (A-3) Linear low- | parts | | | | | | 75 | | | | |
| | density polyethylene | by mass | | | | | | | | | | |
| | resin | | | | | | | | | | | |
| | (A-4) Low density | parts | | | | | | | | | | 75 |
| | polyethylene resin | by mass | | | | | | | | | | |
| | (B-1) Sodium- | parts | | | | | | | 5 | 15 | 25 | |
| | bicarbonate | by mass | | | | | | | | | | |
| | (C-1) Polyethylene | parts | | | | | 3 | | | | | |
| | wax | by mass | | | | | | | | | | |
| Second | (B-1) Sodium- | parts | 25 | 25 | 25 | 40 | 25 | 25 | 20 | | | 25 |
| material | bicarbonate | by mass | | | | | | | | | | |
| feed supply | | | | | | | | | | | | |
| port | | | | | | | | | | | | |

| | | | | | | | | | | | |
|---|---|---|---|---|---|---|---|---|---|---|---|
| Weight loss ratio | mass % | 7.5 | 6.9 | 6.5 | 10.1 | 6.9 | 6.5 | 5.9 | 2.1 | 2.5 | 6.4 |
| Amount of residue | mass % | 15.4 | 15.2 | 15.1 | 24.7 | 15.1 | 15.1 | 12.2 | 9.0 | 15.2 | 15.1 |
| Weight loss ratio/Amount of residue | — | 0.49 | 0.45 | 0.43 | 0.41 | 0.46 | 0.43 | 0.48 | 0.23 | 0.16 | 0.42 |
| Shape retention ratio of pellets | mass % | 100 | 100 | 100 | 100 | 100 | 100 | 100 | 100 | 100 | 100 |
| Observation of classification | — | ++ | ++ | ++ | ++ | ++ | ++ | ++ | ++ | ++ | ++ |
| Extrusion stability | — | +++ | ++ | ++ | ++ | ++ | ++ | ++ | + | + | ++ |
| Die drool | — | +++ | +++ | ++ | + | ++ | ++ | ++ | + | + | ++ |
| Scrapability by scraper | — | +++ | +++ | +++ | +++ | +++ | ++ | +++ | ++ | ++ | + |

### INDUSTRIAL APPLICABILITY

The resin composition of the present disclosure is useful as a purging compound for resin molding processing machines because the thermal decomposition of the inorganic foaming agent is reduced and the residual ratio is extremely high. In addition, it also has a thermal degradation prevention effect, and is particularly effective in preventing degradation of the remaining resin when the machine is stopped.

1. A resin composition comprising at least (A) a polyethylene-based resin having a melting point of 121 to 140° C. and (B) an inorganic foaming agent,
wherein a mass ratio of the (A) component is 50 to 84 parts by mass and a mass ratio of the (B) component is 50 to 16 parts by mass when a total mass of the (A) component and the (B) component is taken as 100 parts by mass, and
a weight loss ratio measured using a thermogravimetric analysis (TGA) apparatus when heated from 25° C. to 200° C. under an inert gas atmosphere is 3.0 to 15 mass %.

2. The resin composition according to claim 1, wherein, when the resin composition is pelletized, the pellets have a shape retention ratio of 99 mass % or more.

3. The resin composition according to claim 1, further comprising (C) a lubricant.

4. The resin composition according to claim 1, wherein the (B) component is at least one selected from the group consisting of sodium bicarbonate, ammonium bicarbonate, ammonium carbonate, and ammonium nitrite.

5. The resin composition according to claim 1, wherein the (B) component is sodium bicarbonate, and an amount of residue when the resin composition is incinerated for 10 minutes under a condition of 600° C. in an air atmosphere is 9.0 mass % or more.

6. The resin composition according to claim 1, wherein the (B) component is sodium bicarbonate, and a ratio of the weight loss ratio to the amount of residue (the weight loss ratio/the amount of residue) when the resin composition is incinerated for 10 minutes under a condition of 600° C. in an air atmosphere is 0.30 to 0.56.

7. The resin composition according to claim 1, wherein a part or all of the (A) component is at least one selected from the group consisting of a material recycled polyethylene-based resin, a chemically recycled polyethylene-based resin, and a biomass-derived polyethylene-based resin.

8. A production method of the resin composition according to claim 1, comprising a melting-kneading step of melting-kneading the (A) component and the (B) component, the melting-kneading step comprising the following step (1-1) and step (1-2):
the step (1-1) of melting-kneading a part or all of the (A) component and a part of the (B) component; and
the step (1-2) of adding, to a melt-kneaded product obtained in the step (1-1), a remainder of the (A) component, unless all of the (A) component is used in the step (1-1), and a remainder of the (B) component, and performing melt-kneading.

9. A production method of the resin composition according to claim 1, comprising a melting-kneading step of melting-kneading the (A) component and the (B) component, the melting-kneading step comprising the following step (2-1) and step (2-2):
the step (2-1) of melting-kneading a part or all of the (A) component; and
the step (2-2) of adding, to a melt-kneaded product obtained in the step (2-1), a remainder of the (A) component, unless all of the (A) component is used in the step (2-1), and all of the (B) component, and performing melt-kneading.

10. A thermoplastic resin pellet comprising 100 parts by mass of the resin composition according to claim 1 and 250 to 2000 parts by mass of (D) a thermoplastic resin.

11. A cleaning method of a resin molding processing machine, comprising using the resin composition according to claim 1.

12. A cleaning method of a resin molding processing machine, comprising cleaning a resin molding processing machine using a mixture obtained by dry-blending 100 parts by mass of the resin composition according to claim 1 and 250 to 2000 parts by mass of the (D) thermoplastic resin.
